(19) United States
(12) Patent Application Publication
(10) Pub. No.: US 2024/0215602 A1
(43) Pub. Date: Jul. 4, 2024

(54) Aromatising Food And Beverages

(71) Applicant: Koninklijke Douwe Egberts B.V., Utrecht (NL)

(72) Inventors: Gertjan Hegmanns, Utrecht (NL); Ellen Roos, Utrecht (NL); Ria Brust, Utrecht (NL); Oliver Frank, Munich (DE); Thomas Hofmann, Munich (DE); Christian Hegmann, Munich (DE); Cynthia Klostermann, Utrecht (NL)

(21) Appl. No.: 18/288,788

(22) PCT Filed: May 4, 2022
(86) PCT No.: PCT/EP2022/061981

§ 371 Date: Oct. 27, 2023

(30) Foreign Application Priority Data
May 4, 2021 (GB) 2106330.0

(51) Int. Cl. A23F 5/50; A23F 5/24

(52) U.S. Cl. CPC A23F 5/505; A23F 5/243

(57) ABSTRACT

The invention provides a method of protecting food or beverage material aroma compounds comprising the steps of separating food or beverage material aroma compounds from a food or beverage material, protecting the separated aroma compounds with a protecting group, and storing said protected aroma compounds.

### TECHNICAL FIELD OF THE INVENTION

The present invention relates to methods of aromatising food and beverages, particularly coffee, and to protecting food and beverage aroma compounds, and to a kit and apparatus for producing aromatised coffee.

### BACKGROUND TO THE INVENTION

Coffee is one of the most consumed beverages in the world today and is made by the extraction of roast and ground coffee beans with hot water. Coffee brew is extremely complex from a chemical perspective since it contains many different volatile and non-volatile compounds that contribute to the flavour and aroma of the coffee and the overall experience of the consumer. Brewing coffee can be done in different ways depending on the whether the coffee is to be consumed at home, at work or in a café.

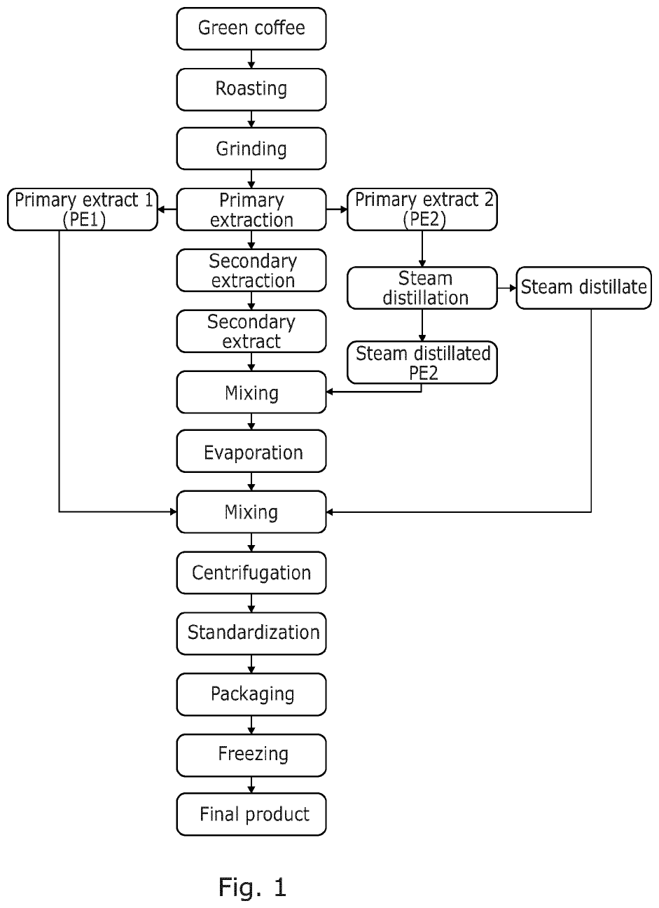

Liquid coffee concentrate is a product that is typically used in coffee machines intended for the professional market. It's made by extensive extraction of roast and ground coffee beans followed by the evaporation of water. The liquid coffee concentrate is packaged and then frozen or stored under ambient conditions to produce frozen liquid coffee concentrate or ambient liquid coffee concentrate respectively. An example of a typical production method for liquid coffee concentrate is shown in FIG. 1. Ambient liquid coffee concentrate has a shelf life of around seven months while frozen liquid coffee concentrate has a shelf life of around 12 months. Within the shelf life of both ambient liquid coffee concentrate and frozen liquid coffee concentrate, the concentration of aroma compounds reduces over time due to certain aroma compounds degrading or reacting with the other coffee compounds, but at differing rates. Some aromas may also degrade in frozen liquid coffee but not ambient, and vice versa. For example, Strecker aldehydes, esters and ethenyl compounds are more stable when frozen, and degrade more quickly when stored under ambient condition. A reduced concentration of aroma compounds in the liquid coffee concentrate tends to result in coffee with a flattened smell and taste which is undesirable for the consumer.

In light of the above it is an aim of embodiments of the invention to provide a method for preparing liquid coffee concentrate that enables coffee to be prepared with an improved taste and smell.

It is also an aim of embodiments of the invention to provide a method which prevents or reduces degradation of aroma compounds in liquid coffee concentrate during storage.

It is another aim of embodiments of the invention to provide a method for protecting aroma compounds that is reversible.

### SUMMARY OF THE INVENTION

According to a first aspect of the invention there is provided a method of protecting food or beverage material aroma compounds comprising the steps of separating aroma compounds from a food or beverage material, protecting the separated aroma compounds with a protecting group, and storing said protected aroma compounds.

The aroma compounds may be selected from the group comprising coffee, tea, cocoa and fruit aroma compounds.

Preferably the method is a method of protecting coffee aroma compounds and the food or beverage material is coffee.

According to a second aspect of the invention there is provided protected food or beverage material aroma compounds comprising an adduct of one or more food or beverage material aroma compounds with a protecting group.

The protected aroma compounds may be selected from the group comprising coffee, tea, cocoa and fruit protected aroma compounds.

Preferably the protected aroma compounds are protected coffee aroma compounds.

By “protecting group” we include, but are not limited to, a separate compound that binds with or reacts with the aroma compounds in a way which is reversible, and which may form an adduct, complex or compound with the aroma compound.

The protected coffee compounds may be in solution.

In preferred embodiments of the first and second aspects of the invention the aroma compounds are aldehydes and the protecting group comprises an acetal. In some embodiments the aldehydes are protected by forming an acetal adduct using a polyol compound. The polyol compound may be selected from quinic acid, or a chlorogenic acid ester of quinic acid, which may be an ester of a hydroxycinnamic acid with at least 2 hydroxy groups on the acid and quinic acid, for example. Examples of hydroxycinnamic acid esters include ester of 5-O-caffeoylquinic acid, 5-O-feruloylquinic acid or 5-O-p-cumaroylquinic acid.

It has been surprisingly found that beneficial aroma compounds of food or beverage materials (such as coffee) can be protected for later addition to a food or beverage, in particular protected coffee aroma compounds for addition to, liquid (at ambient temperatures and pressures) or frozen coffee extract, by protection using protecting groups to form reversible adducts which enable release of the aroma compounds during subsequent food or beverage preparation, such as coffee preparation or brewing.

According to third aspect of the invention there is provided a method of aromatising a food or beverage material, the method comprising the steps of:
a. separating food or beverage material aroma compounds from a food or beverage material;
b. protecting the separated aroma compounds with at least one protecting group;
c. storing the protected aroma compounds separately to a food or beverage material; and
d. combining the protected aroma compounds with a food or beverage material to release the aroma compounds from the protecting group.

According to a fourth aspect of the invention there is provided a method of aromatising coffee, the method comprising the steps of:
a. separating coffee aroma compounds from coffee;
b. protecting the separated coffee aroma compounds with at least one protecting group;
c. storing the protected aroma compounds separately to coffee; and
d. combining the protected coffee aroma compounds with coffee to release the coffee aroma compounds from the protecting group.

Step (c) may comprise storing the protected aroma compounds separately to a liquid coffee concentrate. Step (d) may comprise combining the protected coffee aroma compounds with a liquid coffee concentrate. The liquid coffee concentrate in steps (c) and (d) may be derived from coffee from which the aroma compounds have been stripped in step a. or may be derived from a different coffee starting material. The liquid coffee concentrate may be stored at ambient conditions, or may be stored under chilled conditions (<10° C.) or may be frozen and thawed before step (d).

The following statements apply to each of the first to fourth aspects of the invention, as applicable.

The coffee may be roast coffee or a coffee extract. In some embodiments the roast coffee is whole bean roast coffee or roast and ground coffee. In other embodiments the coffee extract may be a primary, secondary or tertiary or mix of primary, secondary of tertiary extracts, further extract, preferably primary. The methods of the invention can also be applied to partially extracted roast coffee, or spent coffee grounds.

The coffee may be a roast and ground coffee extract and may comprise an extract of roast and ground coffee in aqueous solution (which may also be called “liquid coffee” herein). The coffee may comprise a concentrated aqueous solution of roast and ground coffee extract comprising at least 15% wt., 20% wt., 22.5% wt., 25% wt. or at least 27.5% wt. coffee solids. In some embodiments the coffee may comprise a concentrated aqueous solution comprising at least 30% wt., 40% wt., or at least 50% wt. coffee. A preferred range of coffee concentration is between 15 and 55% wt. In some embodiments the coffee may be formed from a primary extract, secondary extract, tertiary extract or any combination thereof.

The coffee aroma compounds may be separated from the coffee by steam distillation. In one embodiment, a primary coffee extract solution may be subject to steam distillation. Accordingly, the separated coffee aroma compound may be present in steam distillate.

The coffee aroma compounds preferably comprise aldehydes. Suitably, the aldehydes comprise Strecker aldehydes. Strecker aldehydes are generally formed during roasting, from the amino acid precursors present in green (unroasted) coffee beans. In particular, the Strecker aldehydes may comprise acetaldehyde, 2-methylpropanal, 2-methylbutanal and 3-methylbutanal; and in some embodiments are present in a steam distillate.

When the coffee aroma compounds comprise aldehydes, suitably Strecker aldehydes, these may be protected by forming a reversible acetal adduct of the aldehyde. Thus, the aldehyde may be protected with an acetal protecting group.

The acetal protecting group or adduct may be formed by reacting the aldehydes with a protecting compound. The aldehydes may be present in steam distillate. The steam distillate may be mixed with the protecting compound to protect the aldehydes.

In one embodiment, the protecting compound may be a compound that naturally occurs in coffee beans. It will be appreciated that the naturally occurring compound could be isolated and used to protect the aldehydes or that a synthetic version of the naturally occurring compound could be used to protect the aldehydes instead.

The protecting compound may comprise a polyol. Polyols are compounds that that comprise multiple hydroxyl groups that are able to react and form acetal adducts with the aldehyde aroma compounds. Advantageously, the reaction between the hydroxyl groups of the polyol and the aldehydes is reversible meaning the aldehyde aroma compounds can be released by exposing the protected aldehydes to conditions that cause hydrolysis of the acetal groups.

The protecting compound may comprise quinic acid, a chlorogenic acid ester of a hydroxycinnamic acid and quinic acid or derivatives thereof. The ester may be an ester of a hydroxycinnamic acid with at least 2 hydroxy groups on the acid and quinic acid, for example. Examples of hydroxycinnamic acid esters include 5-O-caffeoylquinic acid, 5-O-feruloylquinic acid or 5-O-p-cumaroylquinic acid. These chlorogenic acids and quinic acid occur naturally in coffee beans and comprise multiple hydroxyl groups for reacting with the aldehyde aroma compounds.

In some embodiments the reaction between the aldehydes and quinic acid may be carried out at a temperature of between 0-100° C., such as between 10-90° C. In some embodiments the reaction may take place around ambient temperatures, whilst in other, the reaction may take place around 60-70° C. This may be achieved by heating steam distillate within this temperature range. An increased rate of acetal formation was observed when the aldehydes and quinic acid were reacted at a temperature of 60-70° C.

The reaction between the aldehydes and chlorogenic or quinic acid may be carried out at an acidic pH. Suitably, the reaction may be carried out at pH 2.5-5.5, such as 3-5.5 or at pH 3.5-5.5. Acetal formation is acid catalysed and it has been found that fewer acetal groups are formed at higher pH levels.

The reaction between the aldehydes and chlorogenic or quinic acid may be carried out using equimolar concentrations of aldehydes and chlorogenic or quinic acid. Acetal formation between the aldehydes and chlorogenic or quinic acid is fastest when the reaction is carried out using equimolar concentrations of aldehydes and a chlorogenic or quinic acid. Moreover, the use of equimolar concentrations enables high concentrations of acetal groups to be obtained.

In some embodiments the molar ratio of the chlorogenic or quinic acid:aldehyde may be from 50:1 to 1:50, from 25:1 to 1:25, from 10:1 to 1:10, or from 5:1 or 1:5. When non-equimolar molar concentration ratios are used acetals can still be produced in good numbers, albeit at a slightly reduced rate.

The total concentration of aldehydes in the steam distillate may be between 1 pmol/mL and 1 mmol/mL, so as between 1 nmol/mL and 1 mmol/mL. In some embodiments the concentration of aldehydes is 1, 5, 10, 15 or at least 25 umol/mL. It was found that the reaction between aldehydes and quinic acid is concentration dependent and that a high concentration of acetals was formed when the total concentration of aldehydes and chlorogenic or quinic acid in solution is 25 μmol/mL or more.

The protected aldehydes may be stored at a basic pH. It has been found that the acetals can be stabilised by keeping the acetals at a basic pH, for example by the addition of base. The acetals remain stable in a chlorogenic or quinic acid treated steam distillate when the pH is basic.

Suitably, the acetal-protected aldehydes may be stored at pH 4 to pH 10, more preferably pH 5.5 to pH 9 and most preferably at pH7 to pH8.

The protected coffee aroma compounds may be combined with coffee having a temperature of at least 70° C., suitably at a temperature of at least 90° C. For example, this may be achieved by diluting coffee extract concentrate in water at the desired temperature and then adding the protected aldehydes. Alternatively, coffee concentrate, water and the protected aldehydes can be combined simultaneously. It has been observed that acetal hydrolysis commences at 70° C. or higher and that a significant increase in the rate of hydrolysis can be obtained when the temperature is increased to at least 90° C.

Steam distillate comprising the protected aldehydes may be diluted before use. In some embodiments, dilution may be up to 1000-fold, such as by 10-30 times, by 15-25 times, or by around 20 times. Such dilutions may occur when a user prepares a hot coffee brew from a coffee machine for example.

The hot liquid coffee brew will be slightly acidic and the pH will be between pH 4.5-5.5. An acidic pH such as that found in hot coffee solution is very suitable for release of bound aroma aldehydes by hydrolysis of acetal protecting groups. It was found that the aldehyde aroma compounds could be released at an increased rate when the pH of the solution was at pH 3.5-5.5. At such pH, the acetal adduct reversibly forms the separate aldehyde and protecting compound (e.g. polyol) to release the aroma and increase the beneficial aroma in the in the coffee.

According to a fifth aspect of the invention there is a provided a beverage preparation apparatus, the apparatus comprising a first container for storing a beverage material and a second container for storing protected beverage aroma compounds produced according to the first aspect of the invention, and a water source and a heater, wherein the apparatus is configured to combine the beverage material, the protected aroma compounds and heated water upon activation of the apparatus by a user.

The beverage material is preferably coffee, and the protected beverage aroma compounds are preferably protected coffee aroma compounds.

The apparatus according to the fifth aspect of the invention may, as appropriate, include any or all of the features described in relation to the first to fourth aspects of the invention.

The apparatus may be a coffee preparation apparatus capable of separately receiving containers for storing coffee and the protected coffee aldehyde compounds.

In some embodiments the apparatus may comprise three containers. In these embodiments first and second containers may store coffee and the protected coffee aroma compounds respectively, and a third container may comprise milk, for example.

In some embodiments, the second container may comprise a chlorogenic acid or quinic acid-treated steam distillate. The chlorogenic acid or quinic acid steam distillate may comprise protected Strecker aldehyde aroma compounds. The chlorogenic acid or quinic acid steam distillate may have a pH of 7-8.

In some embodiments the protected aroma compounds may be sterilized, such as, for example, by thermal treatment (e.g. 136° C. or more for at least 4 seconds, preferably around 6 seconds). The sterilized product may then be packaged in aseptic packaging, such as an aseptic pouch, bag or other container.

The first, second and third containers may be removable from the apparatus. Removable containers enable the containers to be disposed of or refilled as appropriate.

According to a sixth aspect of the invention there is provided a kit for producing aromatised coffee, the kit comprising coffee stored in a first container and protected aroma compounds stored in a second container.

The coffee may be as described above and may be a coffee extract solution, such as a concentrate, or so-called “liquid” coffee. The coffee extract solution or liquid coffee may be frozen or may be stored at ambient conditions.

The kit according to the sixth aspect of the invention may, as appropriate, include any or all of the features described in the relation to the first to fifth aspect of the invention.

The kit may additionally comprise a third container, e.g. for milk.

The second container may comprise a chlorogenic acid or quinic acid treated coffee aroma, which may be in the form of a steam distillate. The pH of the chlorogenic acid or quinic acid coffee aroma may be pH 7-8.

The first and second containers may be adapted for use in the apparatus according to the fifth aspect of the invention.

### DETAILED DESCRIPTION OF THE INVENTION

In order that the invention may be more clearly understood one or more embodiments thereof will now be described, by way of example only, with reference to the accompanying drawings, of which:

FIG. 1 shows a processing scheme for producing liquid concentrate coffee.

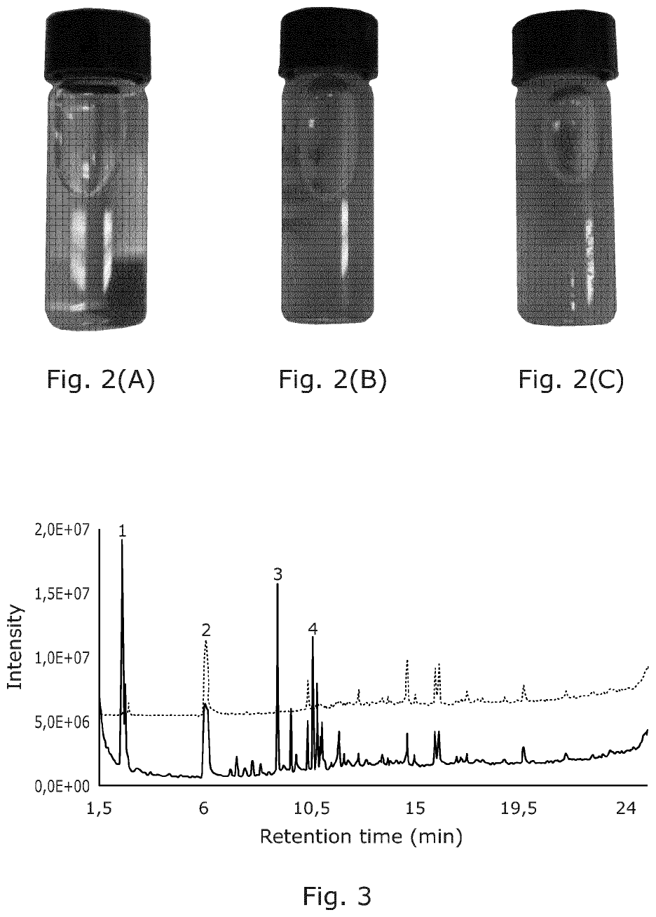

FIG. 2 shows the results of experiments for determining formation of acetals with quinic acid within coffee aroma steam distillate according to the invention;

FIG. 3 shows a chromatogram confirming the formation of acetals with quinic acid within the coffee aroma steam distillate according to the invention;

### MATERIALS AND METHODS

### Materials Used

Strecker aldehydes 3-methylbutanal, 2-methylbutanal, 2-methylpropanal and acetaldehyde were obtained from Sigma-Aldrich (St. Louis, MO, USA). Quinic acid and 1,2-Dihydroxybenzene-d₆ were also obtained from Sigma-Aldrich (St. Louis, MO, USA). Anhydrous sodium acetate was obtained from J.T.Baker (Center Valley, PA, USA). Sodium hydroxide, tert-Butyl methyl ether, ethanol, acetic acid, formic acid and heptafluorobutyric acid were bought from Merck (Kenilworth, NJ, USA), as was sodium sulphate. Acetonitrile was obtained from VWR International (Radner, PA, USA) and tetrabutylammonium hydroxide was acquired from Thermo Fisher Scientific (Waltham, MA, USA). Water used for all experiments was prepared using a MilliQ (MQ) purification system with a 0.22 μm filter unit (Merck Millipore, Billerica, MA, USA).

Stock solutions of 3-methylbutanal and quinic acid in Milli Q water were prepared. Equimolar solutions with at total concentration of 6, 10 and 25 μmol/mL 3-methylbutanal and quinic acid were incubated for 0, 24 and 48 h at 60° C. After incubation, samples were stored at 4° C. until lc-ms measurement.

### Analytical Methods

### Physical Methods

pH was measured with a 744 pH meter of Metrohm (Herisau, Switzerland). Iso-dry matter was measured as described by the method FC-09 Dry Matter (70 gr, reduced pressure). Density Meter Analyzer (DMA) was used to measure dry matter in the range of 0-2.5%. The measurement was performed according to the method Determination of the Dry Matter content as derived from the density (DMA).

Determination of Acetals with Liquid Chromatography—Mass Spectrometry

Liquid chromatography—mass spectrometry was used to detect and analyse acetals formed after incubation of quinic acid with 3-methylbutanal. An Acella autosampler, Acella pump and TSQ Quantum Ultra with Hyperquads (Thermo Fisher Scientific, Waltham, MA, USA), was used for lc-ms analysis, in combination with an Acquity ULPC column, HSS T3 1.8 μm, 2.1×100 mm (Waters, Milford, MA, USA). The eluent consisted of (A) 0.1% formic acid in MQ and (B) 0.1% formic acid in acetonitrile, with a flow of 300 uL/min. The first 4 minutes were run isocratic with 99% A. From 4-25 minutes, the linear gradient used was from 99% A to 100% B, followed by 3 minutes of 100% B. The last 7 minutes were run isocratic with 99% A. The mass spectrometer analysed full scan in the range of 50-650 m/z in negative mode, with a skimmer offset (V) of 10 and a scan time of 0.2 seconds. The injection volume was 5 uL. As an internal standard 1,2-Dihydroxybenzene-d₆ was used. For this internal standard, 25 mg 1,2-Dihydroxybenzene-d₆ was dissolved in 10 mL acetonitrile. Of this stock solution, 10 μL was added to 0.5 mL sample, just before lc-ms analysis. The stock solution was stored at −20° C. in between measurements.

### Gas Chromatography—Mass Spectrometry

Semi-volatile aromas of a 1% dry matter coffee sample were extracted by solid phase extraction. Subsequently, the trapped aromas were eluted from the column with tert-Butyl methyl ether. Naphthalene was added as an internal standard and samples were analysed by a Thermo trace gas chromatograph connected to a Thermo TSQ triple quad MS/MS, both obtained from Thermo Fisher Scientific (Waltham, MA, USA).

Semi-volatile aromas were also quantified by liquid-liquid extraction. A 1% dry matter coffee brew was extracted 1/1 with tert-Butyl methyl ether for 30 minutes during shaking. Naphthalene was added as an internal standard. After liquid-liquid extraction, the upper layer was dried on sodium sulphate and centrifuged for 10 min at 14,500 g, followed by analysis as described previously. To analyse the aroma profile of steam distillate, a 1% dry matter brew of Cronat Gold Jacobs was prepared. 100 μL steam distillate was spiked to 9.9 mL coffee brew, after which SPE and LLE extraction was performed.

### Gas Chromatography—FID/FPD

Volatile aroma compounds were quantified according by purge and trap. Five grams of 1% coffee brew was added to a 40 mL headspace vial, containing 1.25 g NaCl. The sample was analysed by a Thermo Tracé gas chromatograph ultra with FID and FPD detectors (Thermo Fisher Scientific, Waltham, MA, USA), a cold trap (Thermo Fisher Scientific, Waltham, MA, USA) and a Tekmar Stratum purge and trap system (Teledyne Tekmar, Mason, Ohio, USA). The column used was a J& W DB-Wax of 60 m, 0.25 mm ID, 0.5 μm (Agilent Technologies, Santa Clara, CA, USA). For the aroma profile of steam distillate, a 1% dry matter brew of Cronat Gold Jacobs® was prepared, to which 10 and 20 μL steam distillate was added to 5 mL coffee brew.

### Example 1

### Acetal Formation in Steam Distillate

### Preparation of Acetal Stock Solution and Control

Liquid coffee concentrates (primary and secondary coffee extract) from 100% Arabica blend coffee in solution were prepared, concentrated to approximately 29% wt. coffee solids, as made using the process of FIG. 1. In addition, a primary extract and steam distillate of the primary extract (hereinafter “SD(PE)SD(PE)”) of the same 100% Arabica blend were prepared for a further reversibility test of aldehyde-acetal adduct formation. SD(PE) contained aroma compounds, and was then used for further experimentation.

SD(PE) was first analysed for its volatile aroma profile. The total molar mass of acetaldehyde, 2-methylpropanal, 2-methylbutanal and 3-methylbutanal present in the SD(PE) was quantified by headspace aroma analysis.

Then an equimolar concentration of quinic acid was added to 4 mL SD(PE) and incubated for 2 h at 70° C. to form an acetal protecting group on the aldehydes present in the steam distillate. The sample was immediately cooled down on ice and the acetals were stabilised by the addition of 2.5 M NaOH to reach a pH of 9. The acetal adduct rich SD(PE) steam distillate was then stored at 4° C. until required. In addition, a control sample was prepared by incubation of steam distillate for 2 h at 70° C. without addition of quinic acid. The same amount of 2.5 M NaOH was added as in the sample with quinic acid. LC-MS results showed formation of acetal adducts.

### Example 2

### Reversibility of Acetals in Buffers and Coffee Brew

A liquid coffee concentrate (100% Arabica) was made with coffee concentrate (as described above for Example 1). Water was added to reach a final dry matter content of 27.5%. From this liquid coffee concentrate, a brew was made with 1.3% dry matter. In addition, buffers of 100 mM sodium acetate with a pH of 3.5, 4.5, 5 and 5.5 were prepared. The coffee brew and the buffers were divided over closable glass tubes, containing 14.95 mL of the liquids. These tubes were heated to 90° C. After they reached 90° C. 50 μL of acetal rich steam distillate as prepared hereinabove in Example 1 was added and samples were incubated for 1, 5, 10, 30 and 60 minutes at 90° C. Also, a t=0 reference was included, which was not heated to 90° C. After the incubation time was reached, samples were cooled down on ice immediately. Both samples were analysed for their acetal content by lc-ms, volatile aromas and quinic acid content.

The lc-ms results showed acetal hydrolysis in the coffee matrix (which had a pH of 5.05) and showed that acetal formation was reversible, leading to a release of aldehyde aroma.

### Example 3

### Effect of Concentration

Quinic acid and 3-methylbutanal were incubated in an equimolar ratio but at different concentrations. Acetals are formed after 0 h of incubation. Furthermore, the three different concentrations tested 6, 10 and 25 μmol/mL) showed an increase of acetal area over time. The incubation performed at the highest concentration, 25 μmol/mL, showed the most acetal formation after 48 h of incubation. The samples were stored at 4° C. after they had reached their incubation time and were analysed thereafter. The results showed that quinic acid and 3-methylbutanal were able to form acetals at low temperatures and that acetal formation increases exponentially with concentration.

### Example 4

### pH Impact on Acetal Formation Between Quinic Acid and 3-Methylbutanal

Incubations were performed in buffered systems with a pH of 10, 6.5, 5.5 and 4.5, 3.5. pH 10 was included, since most reactions are both acid and base catalysed. At pH 10, no acetals were formed, at pH 6.5 some acetals were formed after incubation and at pH 5.5 more acetals were formed. At pH 4.5 the acetal area increased significantly within the first 24 h of incubation, but afterwards a degradation of acetals was observed. Incubation performed at pH 3.5 resulted in the most acetals being formed and at this pH the acetal area remained substantially the same after 24 h of incubation. Therefore, the results in showed that the reaction mechanism for acetal formation is pH dependent and at lower pH levels, more acetal formation takes place, whereas at higher but still acidic pH, less acetal formation takes place. The results also showed that at the lowest pH, pH 3.5, the acetal area stabilises over time, whereas a large decrease of acetals can be observed at pH 4.5. This suggests that acetals are more stable at pH 3.5.

### Example 5

Effect of Incubation Temperature on Acetal Formation Between Quinic Acid and 3-methylbutanal

To establish whether the reaction between quinic acid and 3-methylbutanal is temperature dependent, the reaction was performed at 25, 37, 60 and 70° C. in a buffered system of pH 4.5 and pH 3.5. At pH 4.5 an increase in acetal formation was observed with temperature and time. In particular, acetal formation was found to be faster at 37° C. compared to 25° C. When the incubation was performed at 60° C., acetal formation was very fast within the first 24 h, but afterwards, a decrease in acetal area was observed. The acetal formation at 70° C., was found to be slower than at 60° C., and a decrease in acetal area was observed relative to the number of acetals formed at 60° C. In samples of pH 3.5, the acetal formation mainly took place within the first 24 h, after which the acetal area remained approximately the same for all temperatures, except for incubation at 70° C. For the incubation performed at 70° C. a very fast increase of acetal can be observed within the first hour, but the acetal area was already found to be lower after 24 h of incubation.

### Example 6

Acetal Formation with Other Strecker Aldehydes

Coffee contains other Strecker aldehydes, i.e. in addition to 3-methylbutanal, namely, acetaldehyde, 2-methylpropanal and 3-methylpropanal. Furthermore, the aldehyde furfural is also present in coffee and is known to degrade over time. In order to establish whether these aldehydes are able to form acetals with quinic acid, they were incubated with quinic acid in a ratio of 1:1. The incubated samples were measured on lc-ms and a selected ion monitoring (SIM) was set for the specific m/z of the different acetals. For acetaldehyde acetal this was m/z 217, for 2-methylpropanal m/z 245 and for 2- and 3-methylbutanal this was m/z 259 in negative mode. Strecker aldehydes acetals were formed with quinic acid, though furfural only formed acetals with quinic acid in a trace level. 3-methylbutanal, 2-methylbutanal and 2-methylpropanal form acetals in approximately the same total area. The area of the acetaldehyde acetal was found to be 50% lower, compared to the other three Strecker aldehydes.

### Example 7

### Stabilisation of Acetals

The previous results show that acetals are unstable at higher temperature (70° C.) and at pH 4.5. To establish whether the acetals could be stabilised, an alkaline base was added to an acetal rich solution to increase the pH from 3.5 to 7 or 8. Samples were measured after storage for 24 h at 4 and 25° C. A large increase in acetal concentration was achieved within the first 2 h of incubation and that the reaction is slower during the last two hours of incubation. With the addition of MQ water just before storage, an increase in acetal area was found after storage. This increase was higher for the 25° C. stored sample compared to the sample stored at 4° C. No differences in acetals formation were found between the samples to which NaOH was added to reach pH 7 or 8. Both samples stored at pH 7 or 8 were found to be equal in their acetal area after storage at 4 and 25° C. Therefore, it can be concluded that the acetals can be stabilised in basic conditions, especially between pH7 and 8.

### Example 9

### Reversibility of the Reaction

Quinic acid and 3-methylbutanal were incubated with each other at a concentration of 300 μmol/mL in a molar ratio 1:1 for 2 h at 70° C. After addition of NaOH to increase the pH to a basic environment, the solution was stored at 4° C. Simultaneously, tubes filled with buffer of pH 3.5, 4.5, and 5.5 were heated to 90° C. After the buffers had reached this temperature, acetal stock solution was added and the samples were incubated at 90° C. for 0, 1, 5, 10, 30 and 60 minutes. The samples were cooled down immediately on ice. FIG. 8 shows a relative decrease of acetals in all samples during incubation. The fastest decrease was found when the stock solution was added to a buffer of pH 3.5. The acetal degradation was slower for the pH 4.5 samples, but still around 80% of the acetal had been degraded after 60 minutes of storage at 90° C. Acetals were also added to a 1.3% dry matter coffee brew, made from a medium roast liquid coffee concentrate. This coffee brew was also stored for 60 minutes at 90° C. The acetal hydrolysis in the coffee matrix (pH 5.05) was found to follow a line between acetal hydrolysis in the pH 4.5 and pH 5.5 sample, indicating that acetal degradation is a pH dependent reaction.

### Example 10

Formation of Acetals with Quinic Acid within Steam Distillate, as Prepared in Example 1

The amount of quinic acid added to the SD(PE) steam distillate of Example 1 was calculated based on the amount of Strecker aldehyde present within the steam distillate. The amount of quinic acid added was a 1:1 molar ratio. FIG. 2 show the results using three samples (A), (B) and (C). Quinic acid treated steam distillate (B) was heated for 2 h at 70° C. and stabilised by the addition of 2.5 M NaOH to a final pH of 9. An unheated quinic acid-treated steam distillate sample (A) was also included, together with a control sample which was heated without quinic acid (C), but with the same amount of NaOH added. FIG. 2 (A-C) shows a large difference in colour after heat treatment with quinic acid and addition of NaOH, indicating that reactions had taken place. The blank steam distillate (A) was light yellow. The steam distillate which was heated with quinic acid and subsequently underwent a pH increase (B) turned orange, whereas the control turned very yellow when the same amount of NaOH was added. The control sample (C), which was made by heat treatment of steam distillate (which had not been quinic-acid treated) followed by addition of the same amount of 2.5 M NaOH as to the quinic acid treated sample (B), turned very yellow.

Samples (B) and (C) were analysed by the lc-ms and the results are shown in FIG. 3, with the darker line being the chromatogram for sample (B) and the lighter line being for sample (C). Many peaks can be distinguished, of which some are both present in the quinic acid treated (B) as the non-quinic acid treated (C) sample. The main differences were the peaks annotated as 1, 3 and 4, which were identified as the acetals made of quinic acid and acetaldehyde (1), quinic acid and 2-methylpropanal (3), and quinic acid and 2- or 3-methylbutanal (4). Peak 2 was identified as the internal standard. Peaks 1, 3 and 4 were present only in sample (B), showing acetal adduct-formation in the sample made by the methods of the invention.

### Example 11

### Aldehyde Rich Coffee

It has been shown that the acetals degraded over time after heat treatment of 0-60 min at 90° C. If the acetals degrade, then free quinic acid and Strecker aldehydes should be found in the solutions. Quinic acid treated coffee steam distillate was added to a buffer solution of pH 3.5, 4.5, 5 and 5.5 and a coffee brew (1.3% dm). For all aldehydes (acetaldehyde, 2-methylpropanal, 2-methylbutanal and 3-methylbutanal) an increase in the amount of Strecker aldehydes was observed relative to samples which had not been heated at 90° C. More Strecker aldehydes could be quantified in headspace after longer incubation of the coffee with the quinic acid treated SD(PE) steam distillate.

In light of the above it can be concluded that that the Strecker aldehydes in steam distillate can be protected by acetals (acetal adducts) made with quinic acid (or chlorogenic acids, other polyols etc. that can form adducts with aldehydes), that these acetals undergo acid hydrolysis during coffee preparation and that this results in an increase of Strecker aldehydes, and therefore aroma, in headspace.

It has been shown that heating coffee steam distillate with quinic acid resulted in the formation of acetals (acetal adducts) and that quinic acid acetals were formed with all Strecker aldehydes (acetaldehyde, 2-methylpropanal, 2-methylbutanal and 3-methylbutanal). The acetals were stabilised at a basic pHof. After spiking stabilised acetal rich mixture to hot (90° C.) buffers and a coffee brew, it has been shown that acid hydrolysis of acetals occurred at all pH levels and that at pH 3.5 acid hydrolysis occurred to 90%. It was also shown that this resulted in a higher concentration of Strecker aldehydes in the headspace. Especially in a coffee brew, spiking of acetal rich solution to the brew and simultaneous storage at 90° C. resulted in a higher amount of Strecker aldehydes quantified in headspace.

The methods described and exemplified hereinabove can be used for different food and beverage materials such as tea, cocoa and fruit. For example tea aroma compounds, cocoa aroma compounds and citrus aromas, especially aldehydes, can be protected in the manner described above and the protected aromas can be added to the same or different origin material.

The one or more embodiments are described above by way of example only. Many variations are possible without departing from the scope of protection afforded by the appended claims.

1. A method of protecting food or beverage material aroma compounds comprising the steps of separating food or beverage material aroma compounds from a food or beverage material, protecting the separated aroma compounds with a protecting group, and storing said protected aroma compounds.

2. A method of aromatising a food or beverage material, the method comprising the steps of:
a. separating food or beverage material aroma compounds from a food or beverage material;
b. protecting the separated aroma compounds with a protecting group;
c. storing the protected aroma compounds separately to a food or beverage material; and
d. combining the protected aroma compounds with a food or beverage material to release the aroma compounds from the protecting group.

3. A method as claimed in claim 1 or 2, wherein the aroma compounds are coffee aroma compounds and the food or beverage material is coffee, preferably roast coffee, coffee extract or coffee extract steam distillate.

4. A method according to claim 3, wherein the coffee aroma compounds are separated from the coffee by steam distillation.

5. A method according to any one of claim 3 or 4, wherein the coffee aroma compounds comprise aldehydes.

6. A method according to any preceding claim, wherein the protecting group comprises an acetal.

7. A method according to claim 6, wherein the acetal protecting group is formed by reacting an aldehyde with a protecting compound.

8. A method according to claim 7, wherein the protecting compound naturally occurs in coffee or is a synthetic version of the naturally occurring compound.

9. A method according to claim 7 or 8, wherein the protecting compound comprises a polyol.

10. A method according to any of claims 7 to 9, wherein the protecting compound comprises quinic acid or a chlorogenic acid or derivatives thereof.

11. A method according to claim 10, wherein the reaction between the aldehydes and quinic acid is carried out at a temperature of 0-100° C.

12. A method according to claim 10 or claim 11, wherein the reaction between the aldehydes and quinic acid is carried out at an acidic pH.

13. A method according to claim 12, wherein the reaction is carried out at pH 3-7.

14. A method according to any preceding claim, wherein the protected aroma compounds are stored at pH6-pH10.

15. A method according to claim 2 or any of claims 3 to 14 when dependent on claim 2, wherein the protected aroma compounds are protected coffee aroma compounds, which are combined with aqueous coffee extract having a temperature of at least 50° C.

16. A method according to claim 2 or any of claims 3 to 15 when dependent on claim 2, wherein the aqueous coffee extract has a pH of between 3.5 and 6.0.

17. Protected food or beverage aroma compounds comprising an adduct of one or more food or beverage aroma compounds with a protecting group.

18. Protected food or beverage material compounds as claimed in claim 17, comprising protected coffee aroma compounds which are an adduct of one or more coffee aroma compounds with a protecting group

19. Protected food or beverage material aroma compounds according to claim 17 or 18, wherein the aroma compounds comprise aldehydes protected by an acetal protecting group.

20. Protected food or beverage material aroma compounds as claimed in any one of claims 17 to 19, produced by the method of any one of claims 1 to 16.

21. A beverage preparation apparatus, the apparatus comprising a first container for storing a food or beverage material and a second container for storing protected food or beverage material aroma compounds, a water source and a heater, wherein the apparatus is configured to combine the food and beverage material, the protected aroma compounds and heated water upon activation of the apparatus by a user.

22. A kit for producing aromatised liquid coffee, the kit comprising coffee stored in a first container and protected aroma compounds in a second container.
